(19) United States
(12) Patent Application Publication
(10) Pub. No.: US 2020/0329643 A1
(43) Pub. Date: Oct. 22, 2020

(54) Grow Fence Garden Planter and Bird and Small Animal Feeder System

(71) Applicant: Azembla S.A.S., Cartagena (CO)

(72) Inventor: Juan Pablo Moreno, Bogota (CO)

(21) Appl. No.: 16/390,991

(22) Filed: Apr. 22, 2019

(51) Int. Cl. A01G 9/02; A01G 9/12; A01G 9/24; A01K 39/014; A01K 5/01; A47G 7/04

(52) U.S. Cl. CPC A01G 9/022; A01G 9/027; A01G 9/128; A47G 7/04; A01K 39/014; A01K 5/01; A01G 9/24

(57) ABSTRACT

The grow fence garden planter and bird and small animal feeder system for planting vegetation or bird and small animal feeder in limited space by stacking in standard vertical posts and horizontal rail is disclosed. The vertical posts provide structural support to the fence and horizontal rail provide base for growing vegetation. The vertical post can be provided with metallic support for fixing on hard floor. The vegetation can be planted directly in vegetation holes in horizontal rail or can be planted in the vegetation pots. If horizontal rails of grow fence are not being used either as bird and small animal feeder or growing vegetation, the faces of the horizontal rails with holes turned in downwards direction. A feeding platform and bird bath can be also installed in the same way as vegetation pots. A lighting arrangement is provided to illuminate the system in night.

### FIELD OF THE INVENTION

The present invention relates in general to gardening and watching birds and small animals. More particularly invention relates to a fence system to plant vegetations and bird and small animal feeder and providing food and bathing space for them.

### DESCRIPTION OF THE RELATED ART

Vertical planters are popular because of their environmentally friendly nature, pleasant appearance and usefulness in gardening and farming. Vertical planter installed as fences outside and as green wall when inside. When used as grow fences vertical planter is particularly useful in the case when there is less available space in the garden or yard where when implemented keeps off intruder off the property, separating boundaries and maintaining vegetation in the garden. The places where having hedges or fixed tree or plant based fences are not possible pallet fences with vertical posts and horizontal rail with plant space can be used. Additionally one part of gardening is taking care of our feathered and furry friends by providing food and sustenance. Conventionally bird feeder can be categorized into perching, platform and piercing type.

Prior art U.S. Ser. No. 00/582,6375A discloses a modular planter system with plurality of troughs having drainage conduit extending vertically upward and downward through conduit. One problem with this arrangement is that plant cannot be rearranged or reorganized.

Prior art US20110258925A1 discloses a vertical planter includes stackable planter units each with plural sections in which plural plants can be planted. Each section of a planter unit can have a removable faceplate for placing soil in the planter section and planting plants in the soil or potted plants can be placed in the faceplate openings. Although this system is capable of being rearranged and reorganized but it does not have provision for maintaining the system when not being used.

Prior art US20130305601A1 discloses a plant cultivation system cultivating and caring the vertical planter for providing access of essential to each plant by circulatory system but the system cannot be used as grow fences as system does not have vertical posts and horizontal rails. Prior art US20140115959A1 is a device for growing plant on vertical substrate having a flexible curtain wall suspended from a carrier having pockets in it for growing plants but the device cannot be used as a grow fence as device does not have vertical posts and horizontal rails.

Although the prior arts discussed above discloses system for vertical planter but it is not suitable for its use as a bird and small animal feeder.

In order to overcome the above aforementioned problems, there is a strong need and demand for a low-cost and easy to maintain vertical planter providing two options for planting vegetation in a fence and multiple options for bird watching. The fence system is used to grow vegetation and plant bird and small animal feeder providing food and bathing space.

### SUMMARY OF THE INVENTION

The present invention overcomes the above problem by providing a grow fence system for growing vegetation and bird and small animal feeder. The system provides multiple options for planting vegetation directly into vegetation holes of a horizontal rail or planting vegetation using a vegetation pot, which can be inserted into the vegetation holes of the horizontal rails. The system at the same time provides feeder and/or bath for birds and small animal to be placed in the horizontal rail holes.

In view of the foregoing, an embodiment herein provides a grow fence garden planter system for planting vegetation comprising standard vertical posts and horizontal rails. Vegetation can be directly planted into the holes of the horizontal rails or planted in a vegetation pot, which can be inserted into holes of the horizontal rails. The horizontal rail holes are filled with any kind of potting soil for plating vegetation directly into the holes allowing vegetation to grow.

In one of the embodiment the vegetation pots are filled with potting soil and these vegetation pots are placed into the holes or vegetation holes of the horizontal rails. If a particular rail needs to be used as a planter, the face needs to be installed with holes pointing upwards. But if it needs not to be used as a planter, the face is installed with holes pointing downwards. The grow fence garden planter system also involves the installation of lights under the horizontal rails to illuminate the fence during night.

In one of the embodiment, the grow fence system is employed to insert the bird and small animal feeder in the same way as insertion of vegetation pot into the holes of the horizontal rail. The bird and small animal feeder system mainly comprises of a plurality of vertical standard posts providing structural support to the fence. A plurality of horizontal rails is connected with the vertical posts having one face with holes pointing upwards to insert the bird and small animal feeder and bird bath. The horizontal rail holes can further be used to support a feeding platform for birds and small animals or their bath. If horizontal rails of fence is not being used as a bird and small animal feeder its face of the rails installed with holes of the horizontal rail turned pointing downwards. The bird and small animal feeder system also involves the installation of lights under the horizontal rails to illuminate the fence during night.

In one of the embodiment, the lower portion of the vertical post is directly embedded in the ground for vertically installing the fence systems. In another embodiment, the standard vertical post includes a metallic post mounted inside to impart further structural strength. The metallic mounted vertical post s meant to install the grow fence overhard floor such as concrete floor, tiled floor, wood floor, deck floor or floor of like nature.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates the grow fence garden planter system for planting vegetation;

FIG. 2A illustrates a standard vertical post in accordance with the embodiments of the fence systems;

FIG. 2B illustrates a vertical post with a metallic support in accordance with the embodiments of the fence systems;

FIG. 3 illustrates an embodiment of the grow fence garden planter system with vegetation holes of horizontal rail pointing upwards;

FIG. 4 illustrates an embodiment of the grow fence garden planter system with vegetation holes of horizontal rail pointing downwards;

FIG. 5 illustrates an embodiment of the grow fence garden planter system with a vegetation pot;

FIG. 6 illustrates the grow fence garden planter system with soil inserted inside a section of the horizontal rail;

FIG. 7 illustrates the bird and small animal feeder system for bird and small animal feeder and bath;

FIG. 8 illustrates an embodiment of the bird and small animal feeder system with holes of horizontal rail pointing upwards;

FIG. 9 illustrates an embodiment of the bird and small animal feeder system with holes of horizontal rail pointing downwards;

FIG. 10 illustrates an embodiment of the bird and small animal feeder system with feeder and/or bath for birds and small animal; and

FIG. 11 illustrates an embodiment of the combined grow fence system for plating vegetation and bird and small animal feeder and bath.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practised and to further enable those of skill in the art to practice the embodiments herein. Accordingly, the examples should not be construed as limiting the scope of the embodiments herein.

The embodiments herein achieve this by providing a grow fence garden planter and bird and small animal feeder system for growing vegetations as well as installing bird and small animal feeders. The system provides option to either directly grow vegetation into the holes of the horizontal rail or by planting a pot into a specific hole in the horizontal rails.

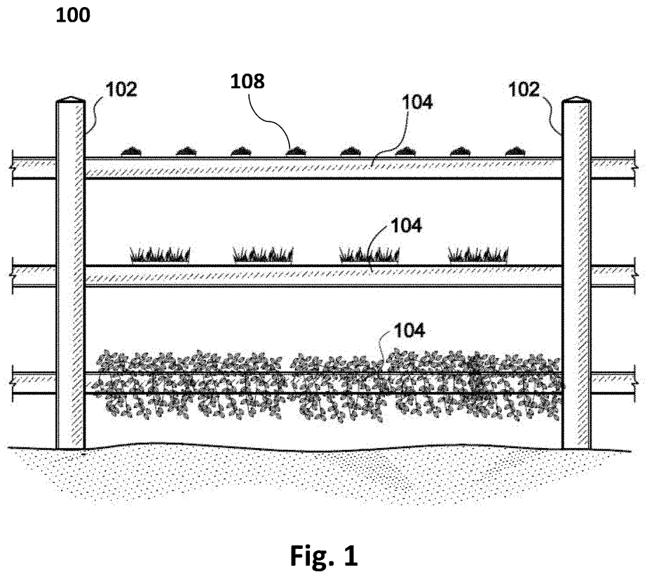

FIG. 1 is an illustration of a grow fence garden planter system (100) for planting vegetation. The grow fence garden planter system (100) comprises of a plurality of standard vertical posts (102) to provide structural support to the fence. The plantation of vegetation is achieved by providing a plurality of holes (110) in a plurality of horizontal rails (104) connected to the plurality of vertical posts (102). The horizontal rails also provide structural support to the system. A plurality of vegetation pots (108) are used for planting vegetation by inserting these vegetation pots (108) into the plurality of holes or vegetation holes (110) provided in the horizontal rails (104). The plurality of vegetation pots (108) can be slipped directly into the horizontal rails (104). A plurality of lights is also installed to the plurality of horizontal rails (104). The system (100) can be provided with various lighting system to illuminate the fence during night.

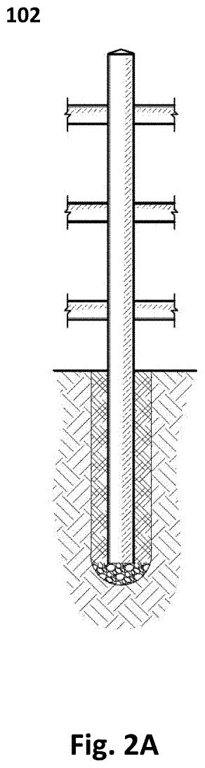

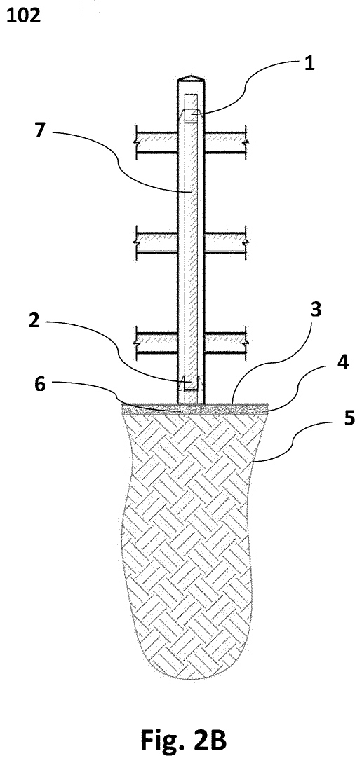

FIG. 2A is an illustration of a standard vertical post in accordance with the embodiments of the fence systems. The standard vertical post (102) provides structural support to the grow fence garden planter system (100), the bird and small animal feeder system (200) and/or the grow fence garden planter and bird and small animal feeder system (300). The vertical post (102) can be fixed into the ground by any conventional method.

FIG. 2B is an illustration of a vertical post with a metallic support to allow the vertical post installed on hard floor in accordance with the embodiments of the fence systems. The vertical post (102) can be used to support the grow fence garden planter system (100), the bird and small animal feeder system (200) and/or the grow fence garden planter and bird and small animal feeder system (300). The vertical post (102) is comprised of metallic support comprising steel elements (1, 2) to adjust the metallic support inside a vinyl vertical post (102). The metallic support can be of steel or other metals. The vertical post with metallic support (102) is installed on the hard floor (3) by the help of wedge anchors (6) using any conventional method such as drilling etc. The wedge anchors (6) penetrate inside the hard floor such as concrete (4).

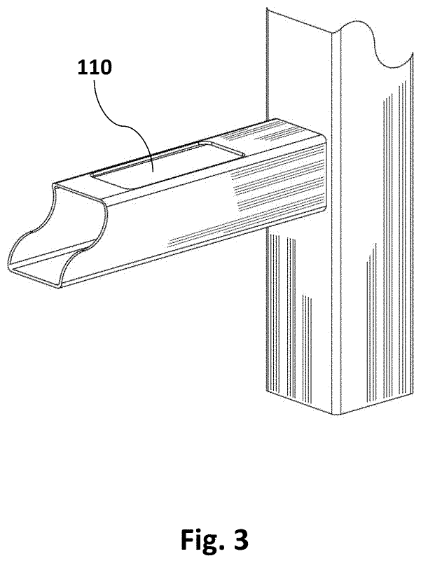

FIG. 3 is an illustration of the grow fence garden planter system (100) with vegetation holes (110) of horizontal rail (104) pointing upwards. The plurality of horizontal rails (104) is filled with any kind of potting soil through vegetation holes (110) allowing plants to grow. If a particular rail (104) is used as a planter for planting vegetation, the face is installed with vegetation holes (110) pointing upwards. The vegetation holes (110) pointing upwards in the horizontal rail (104) can be of any shape or size according to requirement and not restricted to any particular shape or size.

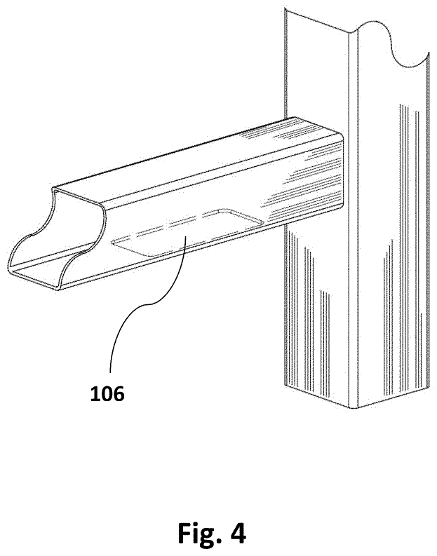

FIG. 4 is an illustration of the grow fence garden planter system (100) with vegetation holes (106) of horizontal rail (104) pointing downwards. The plantation of vegetation is achieved mainly by planting a plurality of horizontal rails (104) connected to the plurality of vertical posts (102) to plant vegetation. If the vegetation needs not to be planted, the vegetation holes (106) of these horizontal rails (104) point downwards.

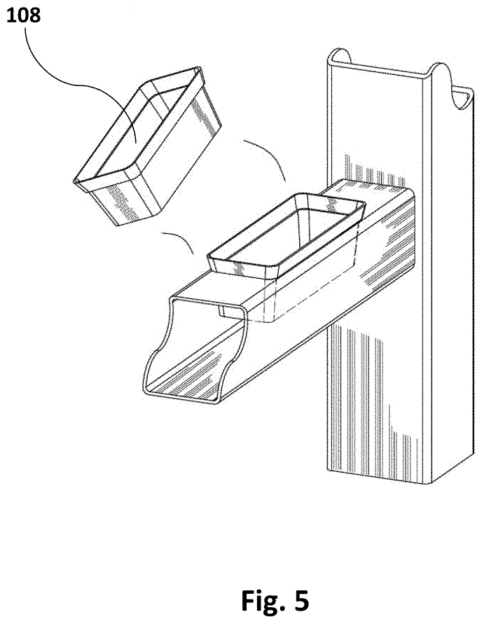

FIG. 5 is an illustration of the grow fence garden planter system (100) with a plurality of vegetation pots (108). These vegetation pots (108) are used for planting vegetation by inserting them into the plurality of vegetation holes (110) provided into horizontal rails (104). These vegetation pots (108) can be of any shape or size according to requirement and not restricted to any particular shape or size and also adjusted according to specific area of horizontal rail (104) to plant vegetation.

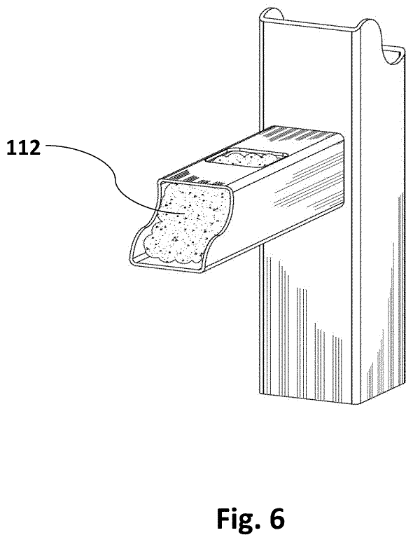

FIG. 6 is an illustration of the grow fence garden planter system (100) with soil (112) inside a section of the horizontal rail (104). The section of horizontal rail (104) is filled with soil (112) which is in the form of mud or any kind of potting soil through vegetation holes (110). Vegetation including flowing and decorative plants can be planted directly into the potting soil (112) through vegetation holes (110).

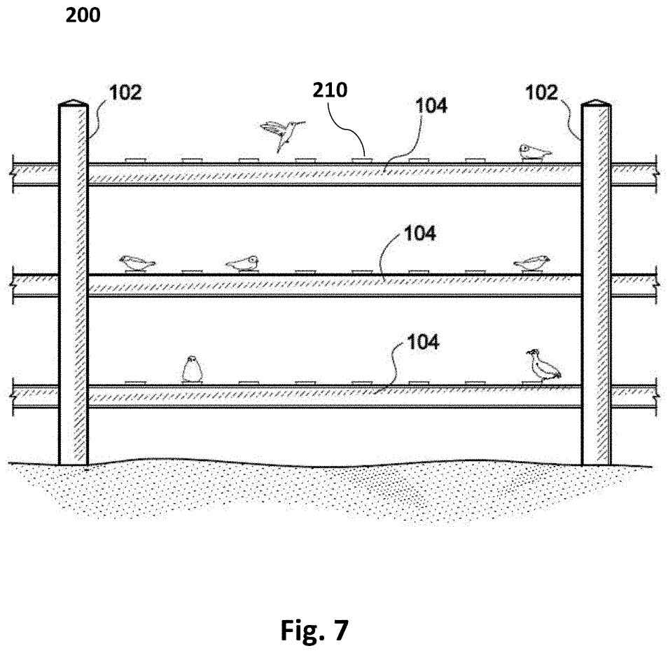

FIG. 7 is an illustration of the fence bird and small animal feeder system (200) for bird and small animal feeder and bath. The fence bird and small animal feeder system (200) comprises of a plurality of vertical posts (102) and horizontal rails (104) to provide structural support to the fence. The system (200) further comprising a plurality of pots (210) which are used for feeding or bathing of the birds and small animals. The bird feeder (210) is used as feeding and bath platform which can be directly placed into the plurality of holes (208) provided in horizontal rails (104).

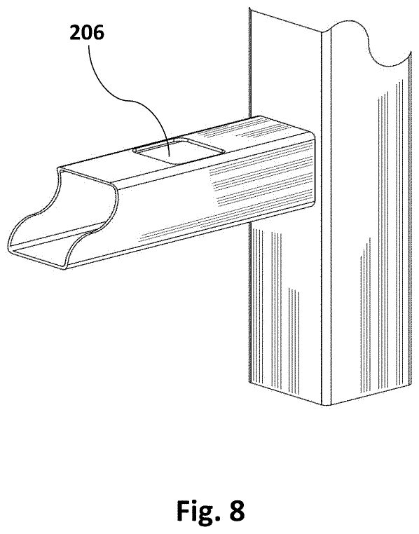

FIG. 8 is an illustration of the bird and small animal feeder system (200) with holes (206) for feeder or bath pointing upwards. The bird and small animal feeder (210) is placed into the holes (206) of the horizontal rails (104) that are connected to the plurality of vertical posts (102). If the bird and small animal feeder has to be planted, these horizontal rails (104) have one face with holes (206) pointing upwards for installing bird and small animal feeder.

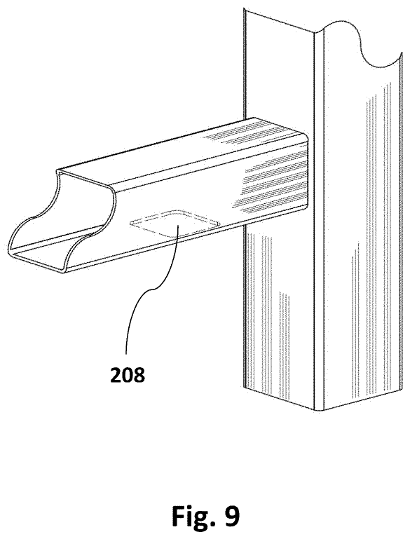

FIG. 9 is an illustration of the bird and small animal feeder system (200) with holes (208) of horizontal rail (104) pointing downwards. If a particular rail needs not to be used for installing bird and small animal feeder, the face of the holes (208) pointing downward. A plurality feeder (210) can be placed into a plurality of holes (208). The plurality of feeder (210) can be used for feeding birds and small animals or as bathing pot (210). A plurality of lights is also provided in the system (200) to illuminate the fence during night.

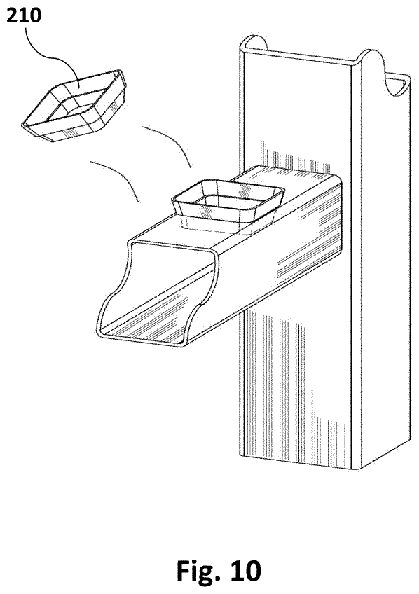

FIG. 10 is an illustration of the bird and small animal feeder system (200) with a plurality of pots (210). These pots (210) can be slipped directly into the plurality of holes (208) provided in the horizontal rails (104) and can be used for feeding bird and small animal. The plurality of pots (210) inserted in the horizontal rail (104) can be of any shape or size according to requirements including feeding or bathing of the birds and small animals and not restricted to any particular shape or size and also adjusted according to specific area of horizontal rail (104).

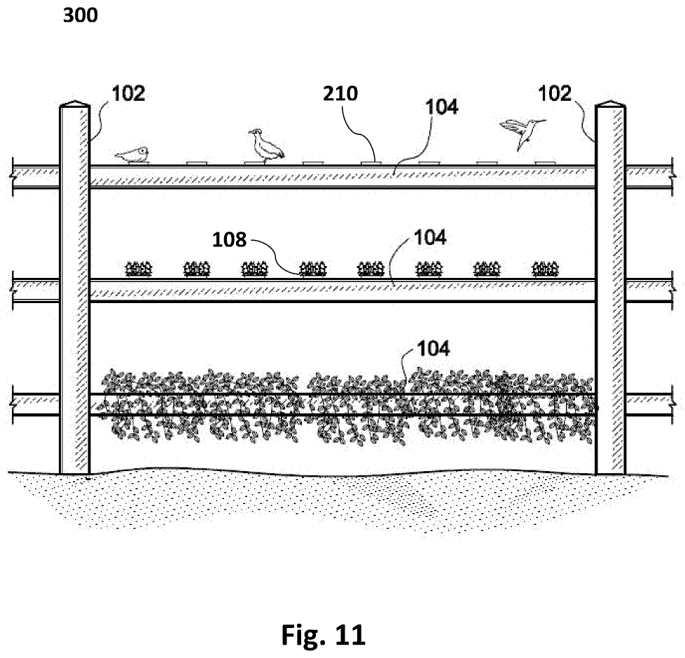

FIG. 11 is an illustration of a grow fence garden planter and bird and small animal feeder system (300) combined together. This composite grow fence garden planter and bird and small animal feeder system (300) comprising of a plurality of vertical posts (102) and plurality of horizontal rails (104) to provide structural support to the fence. The system (300) comprising a plurality of horizontal rails (104) with option to simultaneously using some of the horizontal rails (104) for plating vegetation while others horizontal rails (104) for installing feeder or bath tub for birds and small animals. At least one of the plurality of horizontal rails (104) is filled with any kind of potting soil (112) through vegetation holes (110) allowing plants to grow. The plurality of vegetation pots (108) are filled with potting soil (112) can be placed directly into the plurality of horizontal rails (104) for growing vegetation using vegetation pots (108). The system (300) further comprises at least one horizontal rail (104) for placing feeder or bath tub for bird and small animal. A plurality of lights is also provided in the system (300) to illuminate the fence during night both in case of grow fence garden planter system (100) and bird and small animal feeder system (200).

As mentioned, there remains the foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A grow fence garden planter system for planting vegetation comprising:
a plurality of vertical posts providing structural support to the fence;
a plurality of horizontal rails connected to the plurality of vertical posts,
wherein each the horizontal rail comprising a plurality of vegetation holes.

2. A grow fence garden planter system as claimed in claim 1, wherein the plurality of vegetation holes pointing upwards is filled with potting soil to directly plant vegetation.

3. The grow fence garden planter system as claimed in claim 1, wherein a vegetation pot is placed into each of the plurality of vegetation holes.

4. The grow fence garden planter system as claimed in claim 1, wherein the vertical post comprising a metallic support providing strength to allow the vertical post installation on a hard floor by the help of wedge anchors.

5. The grow fence garden planter system as claimed in claim 1, wherein the system comprises of a plurality of lights installed to illuminate the fence during night.

6. The grow fence garden planter system as claimed in claim 1, wherein the face of the plurality of horizontal rails comprising the plurality of vegetation holes turned downward if the vegetation holes of the particular rail is not used for planting vegetation.

7. A bird and small animal feeder system comprising:
a plurality of vertical posts providing structural support to the system;
a plurality of horizontal rails connected to the plurality of vertical posts,
wherein each of the plurality of horizontal rails comprising a plurality of holes, and
wherein a pot is inserted into each of the plurality of holes.

8. The bird and small animal feeder system as claimed in claim 7, wherein the pot is a feeder for bird and small animal.

9. The bird and small animal feeder system as claimed in claim 7, wherein the pot is used for bathing of bird and small animal.

10. The bird and small animal feeder system as claimed in claim 7, wherein the face of the plurality of horizontal rails is installed with holes pointing downwards if the particular rail is not to be used for placing the bird and small animal feeder or bath.

11. The grow fence garden planter and bird and small animal feeder system as claimed in claim 7, wherein the vertical post comprising a metallic support providing strength to allow the vertical post installation on a hard floor by the help of wedge anchors.

12. The bird and small animal feeder system as claimed in claim 7, wherein system comprises of a plurality of lights installed under the horizontal rails to illuminate the fence during night.

13. A grow fence garden planter and bird and small animal feeder system for planting vegetation and bird and small animal feeder comprising:
a plurality of vertical posts providing structural support to the fence;
a plurality of horizontal rails connected to the plurality of vertical posts,
wherein at least a horizontal rail is provided with a plurality of vegetation holes, and
at least a horizontal rail is provided with holes for installation of pots for birds and small animals.

14. The grow fence garden planter and bird and small animal feeder system as claimed in claim 13, wherein the vegetation holes are filled with potting soils.

15. The grow fence garden planter and bird and small animal feeder system as claimed in claim 13, wherein the vegetation holes are provided with vegetation pots filled with potting soils for growing vegetation.

16. The grow fence garden planter and bird and small animal feeder system as claimed in claim 13, wherein the pots are bird feeder or bath tub.

17. The grow fence garden planter and bird and small animal feeder system as claimed in claim 13, wherein the face of the plurality of horizontal rails is installed with holes pointing downwards if the particular rail is not to be used.

18. The grow fence garden planter and bird and small animal feeder system as claimed in claim 13, wherein the vertical post is a standard vertical post.

19. The grow fence garden planter and bird and small animal feeder system as claimed in claim 13, wherein the vertical post comprising a metallic support providing strength to allow the vertical post installation on a hard floor by the help of wedge anchors.

20. The grow fence garden planter and bird and small animal feeder system as claimed in claim 13, wherein system comprises of a plurality of lights installed under the horizontal rails to illuminate the system during night.
